(19) United States
(12) Patent Application Publication
(10) Pub. No.: US 2010/0325566 A1
(43) Pub. Date: Dec. 23, 2010

(54) EMBEDDED ELECTRONIC DEVICE AND METHOD FOR PROVIDING INTERNET SERVICE THERETO

(75) Inventors: CHIA-PENG WANG, Tu-Cheng (TW); CHUN-WEN WANG, Tu-Cheng (TW); JYH-GWO JU, Tu-Cheng (TW); CHIA-HUNG CHIEN, Tu-Cheng (TW); LIANG-MAO HUNG, Tu-Cheng (TW); TENG-YU TSAI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/565,593

(22) Filed: Sep. 23, 2009

(30) Foreign Application Priority Data
Jun. 19, 2009 (CN) 200910303477.6

(51) Int. Cl. G06F 3/048

(52) U.S. Cl. 715/763

(57) ABSTRACT

An embedded electronic device includes a display, a GUI (Graphical User Interface) application module, a control module, and a content acquisition module. The GUI application module is capable of displaying a GUI on the display. The Internet service management module is capable of controlling Internet service data. The content acquisition module is capable of downloading the Internet service data. The Internet service management module sends a download command to the content acquisition module after the Internet service management module receives a request from the GUI application module. The content acquisition module downloads the Internet service data from an Internet service terminal and transfers the Internet service data to the GUI application module.

### BACKGROUND

1. Technical Field

The present disclosure relates to an embedded electronic device and a method for providing Internet service thereto.

2. Description of Related Art

Embedded devices, for example, digital photo frames (DPFs), are becoming increasingly popular due to their convenience and ease of manipulation when implementing particular functions. However, the typical digital photo frame can only display photos. A DPF receiving Internet service is a desirable market item.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a construction view of an embedded electronic device.

FIG. 2 is a flowchart of a method for providing Internet service to an embedded electronic device.

FIG. 3 is a schematic view of a display of an embedded electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

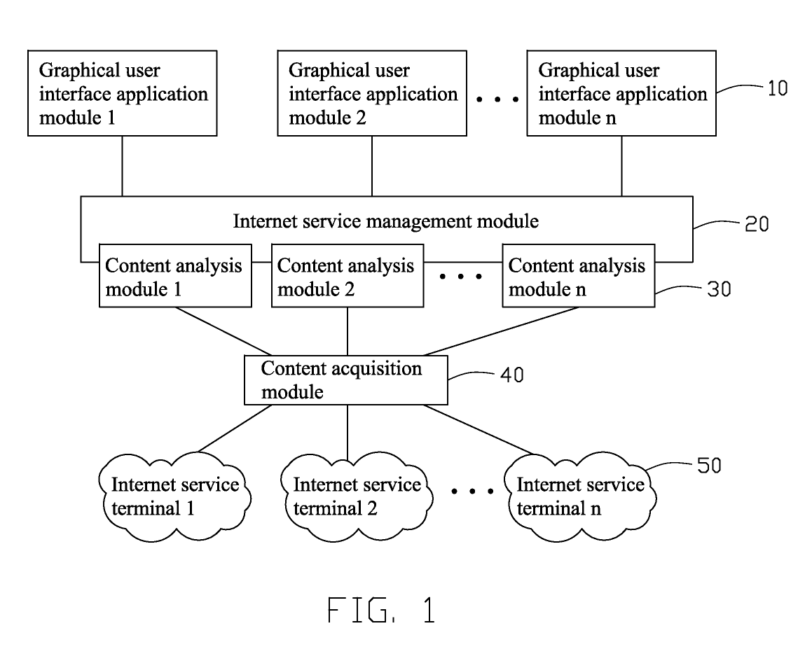

Referring to FIG. 1, an embedded electronic device includes a plurality of GUI (Graphical User Interface) application modules 10, an Internet service management module 20, a plurality of content analysis modules 30, a content acquisition module 40 and a display capable of displaying the GUI application module 10 thereon. A plurality of Internet service terminals 50 connect with the embedded electronic device.

The GUI application module 10 handles all operational modes. For example, the GUI application module 10 can be an Internet news service, Internet radio provider, Internet photo album, an Internet weather service, or many others.

The Internet service management module 20 provides interfaces for the GUI application module 10 to retrieve Internet service data. The Internet service management module 20 executes authentication with the Internet service terminal 50. The Internet service terminal 50 authorizes the Internet service management module 20 to communicate with the Internet service terminal 50. The Internet service management module 20 includes a setting function interface module and a retrieval mode function interface module. The setting function interface module sets a property identifying the GUI application module 10. The retrieval mode function interface module retrieves data information from the content analysis module 30. The Internet service management module 20 stores the Internet service data with specific data structure for the GUI application module 10. For example, the Internet service management module 20 can store a first data structure for Internet radio service and a second data structure for Internet weather service.

Each content analysis module 30 corresponds to the GUI application module 10 and the Internet service terminal 50. The content analysis module 30 has interfaces for the Internet service management module 20 and the content acquisition module 40. The content analysis module 30 extracts information using users defined rules from the content acquisition module 40. For example, when the users download the Internet service data from the content acquisition module 40, the Internet service data may include other unneeded data information. The content analysis module 40 extracts information defined by the user.

The content acquisition module 40 provides interfaces for the content analysis module 30 and the Internet service terminal 50, working asynchronously with the GUI application module 10. When the content acquisition module 40 downloads the Internet service data from the Internet service terminal 50, the GUI application module 10 continues to function. The content acquisition module 40 downloads the Internet service data from the Internet service terminal 50 via multiple threads. The content acquisition module 40 can monitor and display download progress of the Internet service data. The content acquisition module 40 supports a hyper text transfer protocol (HTTP) header to fetch the Internet service data. The content acquisition module 40 can download multi-service content from the Internet service terminal 50. The Internet service terminal 50 provides the Internet service to the content acquisition module 40.

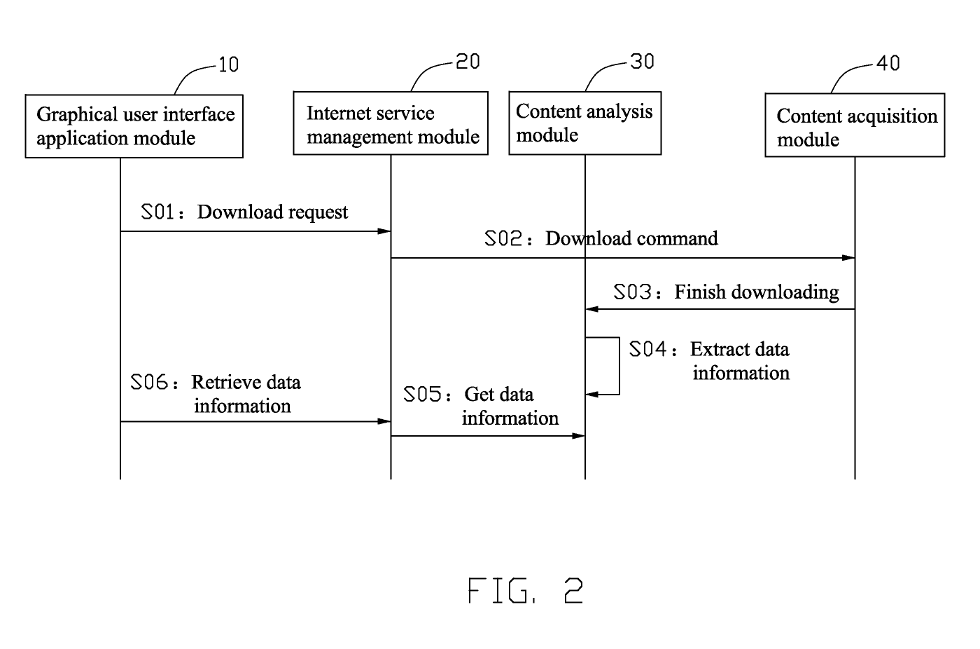

Referring to FIG. 2, a method for providing Internet service in an embedded electronic device includes the following steps:

In step S01, the GUI application module 10 sends a download request to the Internet service management module 20.

In step S02, Internet service management module 20 sends a download command to the content acquisition module 40 through the content analysis module 30.

In step S03, content acquisition module 40 downloads Internet service data from the Internet service terminal 50 and sends the Internet service data to the content analysis module 30.

In step S04, content analysis module 30 extracts useful data information from the Internet service data. If the Internet service data is unsuitable, the content analysis module 30 informs the Internet service management module 20. The Internet service management module 20 sends a command to the GUI application module 10 to restart download.

In step S05, the retrieval mode function interface module of the Internet service management module 20 retrieves the data information from the content analysis module 30. The Internet service management module 20 stores data information with specific data structure.

In step S06, GUI application module 10 retrieves the data information from the Internet service management module 20 and displays the data information.

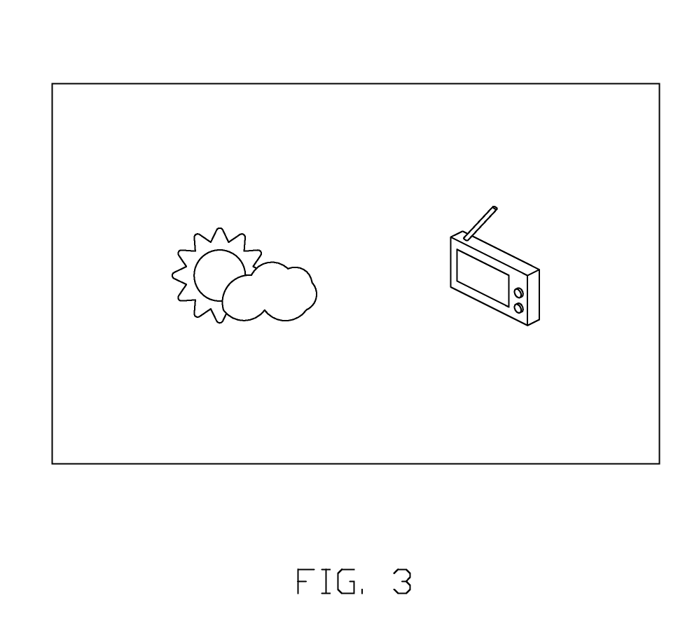

FIG. 3 is a schematic view of a display of the embedded electronic device. When Internet radio service is selected, the embedded electronic device provides the requested service.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. An embedded electronic device, comprising:
a display;
a GUI application module capable of displaying a graphical user interface (GUI) on the display;
an Internet service management module providing Internet service management for the GUI; and
a content acquisition module capable of retrieving Internet service data and transmitting the Internet service data to the Internet service management module;
wherein the Internet service management module is capable of controlling the content acquisition module to retrieve the Internet service data and analyzing the Internet service data before providing it to the GUI application module to be displayed.

2. The embedded electronic device of claim 1, further comprising a content analysis module capable of extracting useful data information from the Internet service data.

3. The embedded electronic device of claim 1, wherein the Internet service management module comprises a setting function interface module for setting the GUI application module, and a retrieval mode function interface module for acquiring the Internet service data from the content acquisition module.

4. The embedded electronic device of claim 1, wherein the content acquisition module is capable of working asynchronously with the GUI application module.

5. The embedded electronic device of claim 1, wherein the content acquisition module is capable of retrieving the Internet service data via multiple threads.

6. The embedded electronic device of claim 1, wherein the Internet service management module is capable of executing authentication to access the Internet service data.

7. The embedded electronic device of claim 1, wherein the Internet service management module is capable of storing the Internet service data in a specific data format.

8. The embedded electronic device of claim 1, wherein the content acquisition module is capable of monitoring and displaying download progress of the Internet service data.

9. The embedded electronic device of claim 1, wherein the GUI application module communicates with the content acquisition module.

10. The embedded electronic device of claim 1, wherein the GUI application module is an Internet radio service module.

11. A method for providing Internet service in an embedded electronic device, comprising:
sending an Internet service request to an Internet service management module through a GUI (Graphical User Interface) application module;
the Internet service management module directing a content acquisition module to implement the Internet service;
the content acquisition module downloading Internet service data from an Internet service terminal and transferring the Internet service data to the Internet service management module;
the Internet service management module analyzing the Internet service data; and
displaying the analyzed Internet service data on the GUI application module.

12. The method of claim 11, further comprising a content analysis module extracting information from the Internet service data.

13. The method of claim 11, wherein the Internet service management module comprises a setting function interface module for setting the GUI application module, and a retrieval mode function interface module for retrieving the Internet service data from the content acquisition module.

14. The method of claim 11, wherein the content acquisition module works asynchronously with the GUI application module.

15. The method of claim 11, wherein the content acquisition module retrieves the Internet service data via multiple threads.

16. The method of claim 11, wherein the Internet service management module handles authentication to access to the Internet service data.

17. The method of claim 11, wherein the Internet service management module stores the Internet service data with a specific data structure.

18. The method of claim 11, wherein the content acquisition module monitors download progress of the Internet service data.

19. The method of claim 11, wherein the content acquisition module supports a hyper text transfer protocol (HTTP) header to retrieve the Internet service data.

20. The method of claim 11, wherein the GUI application module is an Internet radio service module.
